(19) United States
(12) Patent Application Publication
(10) Pub. No.: US 2004/0186755 A1
(43) Pub. Date: Sep. 23, 2004

(54) Method and system of matching service providers with users based on user input

(76) Inventor: Christopher M. Roche, New York, NY (US)

Correspondence Address: ST. ONGE STEWARD JOHNSTON & REENS, LLC, 986 BEDFORD STREET, STAMFORD, CT, 06905-5619, US

(21) Appl. No.: 10/784,625

(22) Filed: Feb. 23, 2004

Related U.S. Application Data
(63) Continuation-in-part of application No. 09/795,296, filed on Jul. 6, 2000, now abandoned.

(51) Int. Cl. G06F 17/60

(52) U.S. Cl. 705/4

(57) ABSTRACT

A system for facilitating the selection and purchase of a service by a user from a service provider is provided. The system includes a computer and a database accessible by the computer, the database having stored thereon information relating to service provider benchmarks. Software is provided for receiving from the user information relating to a desired service. This information is compared, based upon preselected criteria, with the information relating to service provider benchmarks to identify at least one appropriate service provider. Software is also provided for receiving quotes from the at least one identified appropriate service provider in response to requests for proposals, and for transmitting the received quotes to the user.

### CROSS-REFERENCE TO RELATED APPLICATIONS

This is a continuation-in-part of currently pending U.S. patent application Ser. No. 09/795,296, filed Jul. 6, 2000.

### FIELD OF THE INVENTION

The present invention provides a method and system for matching service providers with users based on user input. More specifically, it provides a method and system for ranking insurance service providers according to how closely they meet the needs of insurance users based on user input.

### BACKGROUND OF THE INVENTION

Traditionally, insurance users, i.e., persons or corporations purchasing insurance protection, contact insurance agents or brokers who put together quotes for various insurance products that meet the user's needs. The agents or brokers charge a fee for this service.

Often, agents and brokers have special relationships with certain insurance providers. Therefore, unless the user is aware of those special relationships and contacts those specific agents or brokers, the user cannot be confident that the quotes they receive are necessarily the best available. To make matters worse, agents and brokers often have a financial stake in directing users to a particular insurance provider, even though another insurance provider might be better. Independent brokers who represent multiple insurance providers often have less of a stake in which insurance provider the user ultimately decides to go with, but as a practical matter, the user is likely to be directed towards a few providers that the broker has experience with.

Insurance users, especially business users that normally require multilevel insurance packages such as theft, fire and group benefits (i.e. dental, medical, etc.) are sophisticated consumers in general. In order to compete for their business, insurance service providers need to carefully match an insurance company to the needs of the insurance user.

The Internet has become the research tool of choice for many consumers when shopping for everything from automobiles to clothing. The insurance industry is represented online by many companies offering to find the “best quote” for insurance services. These systems typically ask users to enter information which is then either forwarded to insurance companies for a response or else the system chooses a “best” quote based on the lowest premium available for a particular type of insurance.

The Internet provides a way for insurance users to select an insurance provider, but it lacks the personal tailoring that an agent or broker can provide and offers the user a less tailored solution to meeting their insurance needs. Also, the user can only access information regarding one kind of insurance product at a time. Therefore, the typical business user would have to make repeated entries or searches to find suitable coverages.

There is a need for a low cost, efficient way for insurance users to identify and purchase multiple kinds of insurance protection based on their particular needs.

### SUMMARY OF THE INVENTION

The present invention provides a system and method by which information is user entered, compiled and stored in a database. The database then matches the entered information against at least a second set of criteria previously provided and stored in the database containing information concerning a plurality of service providers to determine potential matches between the user and various service providers. After potential matches have been determined, the service providers are contacted in order to obtain more specific information based on user input. The responses from the various service providers are compiled and ranked by a database system and communicated to the user.

Specifically, the present invention provides a system and method by which a corporate user seeking various types of insurance coverages input their insurance needs into a database. Insurance providers best meeting those needs are contacted to request quotes. The various insurance providers are ranked by the database system after receiving the requested quotes from each of the insurance companies and the ranking is communicated to the user.

The present invention provides a networked computer system linked to a communication network such as the internet such that insurance users input their insurance needs into a database.

The present invention provides a system and method by which inputted data about the insurance user's needs is transmitted to insurance providers.

The present invention provides a system and method by which insurance providers submit quotes tailored by a database that considers user needs and is ranked by the database based on how closely the criteria is matched.

The present invention provides a system and method by which insurance quotes are securely obtained for insurance users tailored to their needs.

The present invention provides a system and method by which insurance providers are ranked according to certain criteria such as location, experience, volume of business, specialty, SIC code(s), etc. in order to match them up with insurance users.

The present invention provides insurance users with a sense of comfort, security, trust, peace of mind and a general level of confidence that the insurance they obtain is closely matched to their needs heretofore not available.

The present invention provides insurance service providers an income generation source based on a percentage of savings generated by users of the present invention.

The present invention provides insurance service providers with an income generation source by charging users a fee to use the present invention.

The present invention provides insurance service providers with and income generation source by charging brokers a fee to participate according to the present invention.

The present invention provides insurance service providers with an income generation source by charging underwriters a fee to participate in the system and method of the present invention.

In accordance with one embodiment of the present invention a system for facilitating the selection and purchase of an insurance policy by a client from a broker includes a computer and a database accessible by the computer, the database having stored thereon broker benchmarks, the broker benchmarks comprising data indicative of at least one broker specialty for each broker. Computer executable instructions embodied on a computer readable medium are provided for receiving from the client information relating to the client and relating to a desired insurance policy. Additional computer executable instructions embodied on a computer readable medium are provided for comparing, based upon preselected criteria, the information relating to the client and relating to the desired insurance policy with the broker benchmarks to identify at least one appropriate broker. Further computer executable instructions embodied on a computer readable medium are provided for generating and transmitting to the at least one identified appropriate broker requests for manually prepared proposals individually tailored to the client. Still further computer executable instructions embodied on a computer readable medium are provided for receiving proposals from the at least one identified appropriate broker in response to the requests for proposals. Additional computer executable instructions embodied on a computer readable medium are provided for transmitting the received proposals to the client.

In some embodiments, the data indicative of at least one broker specialty comprises an alphanumeric code, the information relating to the client comprises an alphanumeric code indicative of a business type of the client, and a broker is identified as being appropriate only if the alphanumeric code which comprises the data indicative of the at least one broker specialty matches the alphanumeric code indicative of the business type of the client. In certain of these embodiments, the alphanumeric code which comprises the data indicative of the at least one broker specialty and the alphanumeric code indicative of the business type of the client comprise SIC codes.

In some embodiments, the broker benchmarks further comprise data indicative of a geographic location of each broker. In certain of these embodiments, the broker benchmarks further comprise, for each broker, data indicative of at least one of an amount of business the broker conducts, a size of the broker, a length of time the broker has been in business, whether the broker is a public or private entity, and whether the broker is a headquarters or a branch location. In some embodiments, the computer executable instructions embodied on a computer readable medium for receiving from the client information relating to the client and relating to a desired insurance policy comprises computer executable instructions embodied on a computer readable medium for transmitting a questionnaire to the client soliciting information relating to the client and relating to a desired insurance policy, and computer executable instructions embodied on a computer readable medium for receiving from the client responses to the questionnaire indicative of information relating to the client and relating to a desired insurance policy. In certain of these embodiments, the system further comprises computer executable instructions embodied on a computer readable medium for receiving from the client an indication of a desired type of insurance policy, and the questionnaire solicits information specific to the desired type of insurance policy.

In some embodiments, the at least one appropriate broker comprises a plurality of appropriate brokers. In some embodiments, the system further includes computer executable instructions embodied on a computer readable medium for generating a contract based upon each received proposal, and for transmitting the contracts to the client along with the received proposals. In some embodiments, the system further includes computer executable instructions embodied on a computer readable medium for receiving from the client an indication of a selected proposal, and for generating and transmitting to the client a contract based upon the selected proposal. In some embodiments, the system further includes computer executable instructions embodied on a computer readable medium for transmitting broker contact information along with the received proposals. In some embodiments, the system further includes computer executable instructions embodied on a computer readable medium for receiving from the client an indication of a selected proposal, and for transmitting to the broker which submitted the selected proposal an indication that the proposal has been selected by the client.

In accordance with another embodiment of the present invention, a system for facilitating the selection and purchase of an insurance policy by a client from a broker, includes a computer and a database accessible by the computer, the database having stored thereon broker benchmarks, the broker benchmarks comprising an alphanumeric SIC code indicative of at least one broker specialty for each broker. Computer executable instructions embodied on a computer readable medium are provided for receiving from the client information relating to the client and relating to a desired insurance policy, the information relating to the client comprising an alphanumeric SIC code indicative of a business type of the client. Additional computer executable instructions embodied on a computer readable medium are provided for comparing, based upon preselected criteria, the information relating to the client and relating to the desired insurance policy with the broker benchmarks to identify at least one appropriate broker, wherein a broker is identified as being appropriate only if the alphanumeric SIC code which comprises the data indicative of the at least one broker specialty matches the alphanumeric SIC code indicative of the business type of the client. Additional computer executable instructions embodied on a computer readable medium are provided for generating and transmitting to the at least one identified appropriate broker requests for manually prepared proposals individually tailored to the client. Further computer executable instructions embodied on a computer readable medium are provided for receiving proposals from the at least one identified appropriate broker in response to the requests for proposals. Still further computer executable instructions embodied on a computer readable medium are provided for transmitting the received proposals to the client.

In another aspect of the present invention, a method for facilitating the selection and purchase of an insurance policy by a client from a broker includes the steps of: providing a database having stored thereon broker benchmarks, the broker benchmarks comprising data indicative of at least one broker specialty for each broker; receiving from the client information relating to the client and relating to a desired insurance policy; comparing, based upon preselected criteria, the information relating to the client and relating to the desired insurance policy with the broker benchmarks to identify at least one appropriate broker; generating and transmitting to the at least one identified appropriate broker requests for manually prepared proposals individually tailored to the client; receiving proposals from the at least one identified appropriate broker in response to the requests for proposals; and transmitting the received proposals to the client.

In some embodiments, the data indicative of at least one broker specialty comprises an alphanumeric code, the information relating to the client comprises an alphanumeric code indicative of a business type of the client, and a broker is identified as being appropriate only if the alphanumeric code which comprises the data indicative of the at least one broker specialty matches the alphanumeric code indicative of the business type of the client. In certain of these embodiments, the alphanumeric code which comprises the data indicative of the at least one broker specialty and the alphanumeric code indicative of the business type of the client comprise SIC codes.

In some embodiments, the broker benchmarks further comprise data indicative of a geographic location of each broker. In certain of these embodiments, the broker benchmarks further comprise, for each broker, data indicative of at least one of an amount of business the broker conducts, a size of the broker, a length of time the broker has been in business, whether the broker is a public or private entity, and whether the broker is a headquarters or a branch location. In some embodiments, the step of receiving from the client information relating to the client and relating to a desired insurance policy comprises the steps of: transmitting a questionnaire to the client soliciting information relating to the client and relating to a desired insurance policy; and receiving from the client responses to the questionnaire indicative of information relating to the client and relating to a desired insurance policy. In certain of these embodiments, the method further comprises the step of receiving from the client an indication of a desired type of insurance policy, and the questionnaire solicits information specific to the desired type of insurance policy.

In some embodiments, the at least one appropriate broker comprises a plurality of appropriate brokers. In some embodiments, the method further comprises the step of generating a contract based upon each received proposal, and transmitting the contracts to the client along with the received proposals. In some embodiments, the method further comprises the step of receiving from the client an indication of a selected proposal, and generating and transmitting to the client a contract based upon the selected proposal. In some embodiments, the method further includes the step of transmitting broker contact information along with the received proposals. In some embodiments, the method further includes the step of receiving from the client an indication of a selected proposal, and transmitting to the broker which submitted the selected proposal an indication that the proposal has been selected by the client.

In accordance with another embodiment of the present invention, a method for facilitating the selection and purchase of an insurance policy by a client from a broker includes the steps of: providing a database having stored thereon broker benchmarks, the broker benchmarks comprising an alphanumeric SIC code indicative of at least one broker specialty for each broker; receiving from the client information relating to the client and relating to a desired insurance policy, the information relating to the client comprising an alphanumeric SIC code indicative of a business type of the client; comparing, based upon preselected criteria, the information relating to the client and relating to the desired insurance policy with the broker benchmarks to identify at least one appropriate broker, wherein a broker is identified as being appropriate only if the alphanumeric SIC code which comprises the data indicative of the at least one broker specialty matches the alphanumeric SIC code indicative of the business type of the client; generating and transmitting to the at least one identified appropriate broker requests for manually prepared proposals individually tailored to the client; receiving proposals from the at least one identified appropriate broker in response to the requests for proposals; and transmitting the received proposals to the client.

Other features and advantages of the present invention will become apparent from the following description of the invention which refers to the accompanying drawings.

### BRIEF DESCRIPTION OF THE DRAWINGS

FIG. 1 is an example of a hardware arrangement for a network-based method and system of ranking service providers according to user input in accordance with the principals of the present invention.

FIG. 2 is a block diagram of the functional elements of an Information Processor and a user terminal constructed in accordance with the principals of the present invention.

FIG. 3 is a flow chart outlining the method according to the principals of the present invention.

FIG. 4 is a flow chart showing an embodiment according to the principals of the present invention.

FIG. 5 is a flow chart of an alternate embodiment organized in accordance with the principals of the present invention.

FIG. 6 is a flow chart of yet another embodiment of a method and system of matching service providers with users according to the present invention.

FIG. 7 is a diagram illustrating a information flow according to the principals of the present invention.

FIG. 8 is a block diagram showing an overall view of a dynamic embodiment according to the principals of the present invention.

### DETAILED DESCRIPTION OF EMBODIMENTS OF THE INVENTION

Referring to the drawing figures in which like reference designators refer to like elements, there is shown in FIG. 1, an example of a hardware arrangement for a method and system of matching service providers with users constructed in accordance with the principals of the present invention and designated generally as 10. System 10 is preferably comprised of at least one Information Processor 12 and at least one user terminal 14 each of which are coupled to communication network 16. Communication network 16 is preferably a global public communication network such as the Internet.

Information Processor 12 and user terminal 14 can be any device capable of sending and receiving data across communication network 20, for example, mainframe computers, mini computers, personal computers, laptop computers, personal digital assistants (PDAs) or Internet access devices such as web TV. In addition, user terminals 14 are preferably equipped with standard web browser such as MICROSOFT INTERNET EXPLORER, NETSCAPE COMMUINTCATOR and the like. Information Processors 12 and terminal 14 are coupled to communication network 16 using any known data communication networking technology.

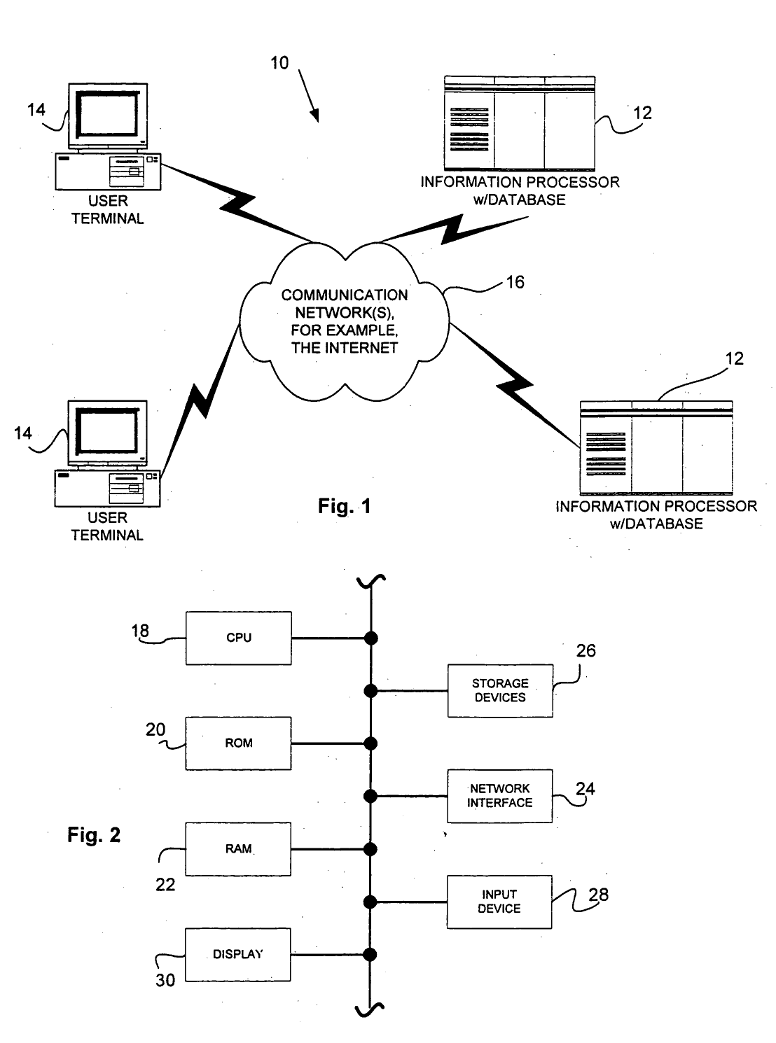

As shown in FIGS. 1 and 2, the functional elements of each Information Processor 12 preferably include one or more central processing units (CPU) 18 used to execute software code in order to control the operation of Information Processor 12, read only memory (ROM) 20, random access memory (RAM) 22, one or more network interfaces 24 to transmit and receive data to and from other computing devices across a communication network, storage devices 26 such as hard disk drive, floppy disk drive, tape drive, CD ROM or DVD for storing program code databases and application data, one or more input devices such as keyboard, mouse, track ball and the like and a display 30.

The various components of Information Processor 12 need not be physically contained within the same chassis or even located in a single location. For example, storage device 26 may be located at a site which is remote from the remaining elements comprising Information Processors 12 and may even be connected to CPU 18 across communication network 16 via network interface 24.

Information Processors 12 include a database equipped with sufficient storage to store product data, user information, passwords and security functions and also preferably to act as a web server for communicating hypertext markup language (HTML), Java applets, Active X control programs and the like to user terminals 14. Information Processors 12 are arranged with components, for example, those shown in FIG. 2 suitable to the expected operating environment of Information Processor 12. For example, the central processing unit or units network interface or interfaces memory and storage capacities are arranged to accommodate the expected demand.

The functional elements shown in FIG. 2 (designated by reference numerals 18-30) are preferably the same categories of functional elements present in user terminals 14. However, not all elements need be present. For example, storage devices in the case of PDAs and the capacities of the various elements are arranged to accommodate the expected user demand. CPU 18 in user terminal 14 may be of a smaller capacity than CPU 18 as present in Information Processor 12. Similarly, it is likely that Information Processor 12 will include storage devices 26 for a much higher capacity than storage devices 26 present in user terminal 14. Of course, one of ordinary skill in the art will understand that the capacities of the functional elements can be adjusted as needed.

The nature of the invention is such that one skilled in the art of writing computer executable code (software) can implement the described functions using one or more or a combination of popular computer programming languages including, but not limited to C++ Visual Basic, Java, Active X, HTML, cold fusion and web development environments.

Although the present invention is described by way of example herein in terms of a web-based system using web browsers and a web site server (information Processor 12), system 10 is not limited to that particular configuration. It is contemplated that system 10 can be arranged such that user terminals 14 can communicate with and display data received from Information Processors 12 using any known communication and display method. For example, using a non-Internet browser window viewer, coupled with a local area network protocol such as the Internet Work Package Exchange (IPX). It is further contemplated that any suitable operating system can be used on terminals 14. For example, WINDOWS 3.X, WINDOWS 95, WINDOWS 98, WINDOWS NT, WINDOWS 2000, WINDOWS MILLENNIUM, Linex, MacOS, Unix, WINDOWS CE, PALM OS and any other suitable PDA or palm computer operating system.

As used herein references used to displaying data on user terminals 14 refer to the process of communicating data to the terminal of cross-communication network 16 and processing the data such that the data can be viewed on the terminal display 30 using a web browser or the like. As is common with web browsing software, the display screen on terminals 14 present linkable portions such that a user can proceed from area to area within the system by clicking on the appropriate link.

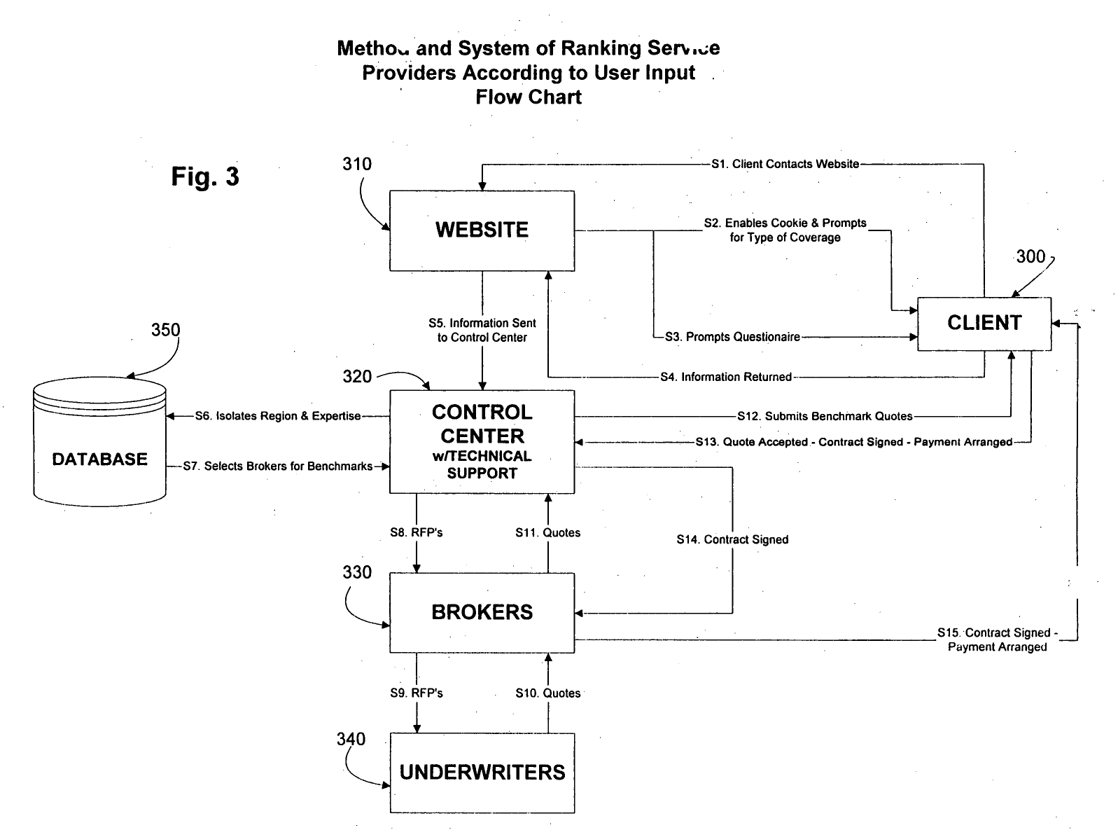

FIGS. 3-6 are flow charts of four embodiments of the overall process as organized according to the principals of the present invention. In the preferred embodiments, client 300 is directed towards website 310. Client 300 may be directed to website 310 through a variety of methods such as e-mails containing an embedded URL to the web site 310, links on other websites, traditional mailings containing the address of the web site 310 or any other appropriate advertising method. When client contacts web site (S1), a cookie is preferably established and client 300 is prompted for the type or types of coverage they are interested in. It is preferred that the required information is collected in the form of a questionnaire (S3) that is generated by the website and merely filled out by client 300. The questionnaire (S3) is preferably tailored to the particular kind of insurance that the user is interested in and is based on the response from initial request (S2). Client 300 then returns the information (S4) to website 310. The questionnaires can be immediately sent to Control Center 320 (S5) or in an alternate embodiment, the information may be pre-screened using software and/or human intervention and then sent to Control Center 320.

Control Center 320 compares the question obtained from the client through the questionnaire with broker benchmark data stored on database 350 and selects appropriate brokers according to such benchmarks (S7). The benchmark data preferably comprises at least data indicative of a broker's area of specialty, which may be identified on the basis of an al phanumeric identifier, such as a Standard Industrial Classification (SIC) code. The benchmark data preferably also comprises at least data indicative of a geographic location (e.g., city, state, country, etc.) of the broker. Additional benchmark data may comprise, for example, an amount of business the broker conducts (e.g., a premium volume of the broker), the size of the broker (e.g., its number of agents and/or employees), the length of time the broker has been in business, whether the broker is a public or private entity, whether the

For example, where the questionnaire indicates that the client is a bowling center in Detroit, Mich., Control Center 320 would query database 250 to identify brokers having a specialty in servicing bowling centers (perhaps by SIC code—7933 for bowling centers), which are located in or near (or at least which service clients in) Detroit, Mich. The list of appropriate brokers may be ranked and/or be further narrowed by any of the above-mentioned further benchmark criteria.

Once appropriate brokers are identified, Control Center 320 generates and transmits to the identified brokers Requests For Proposals (RFP's) (S8). These RFP's are requests for manually prepared proposals, which are individually tailored based upon the particular client which submitted the questionnaire. It should be understood that Control Center 320 does not itself prepare proposals or quotes, but instead acts to pre-screen appropriate brokers based upon benchmarks as described above and to request proposals therefrom. At no time does Control Center 320 itself generate quotes or proposals. It should also be understood that while proposals received from the appropriate brokers as a result of the RFP's may include quotes, such is not always the case. The proposals (being manually prepared), may include requests for further information from the client, for example.

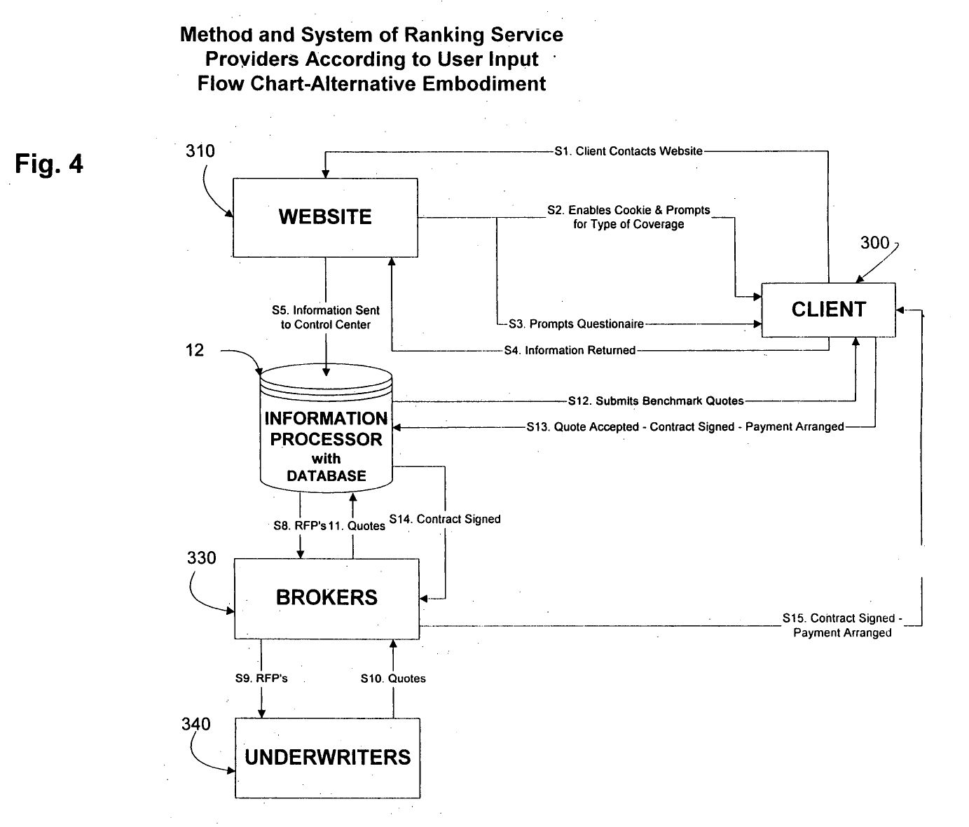

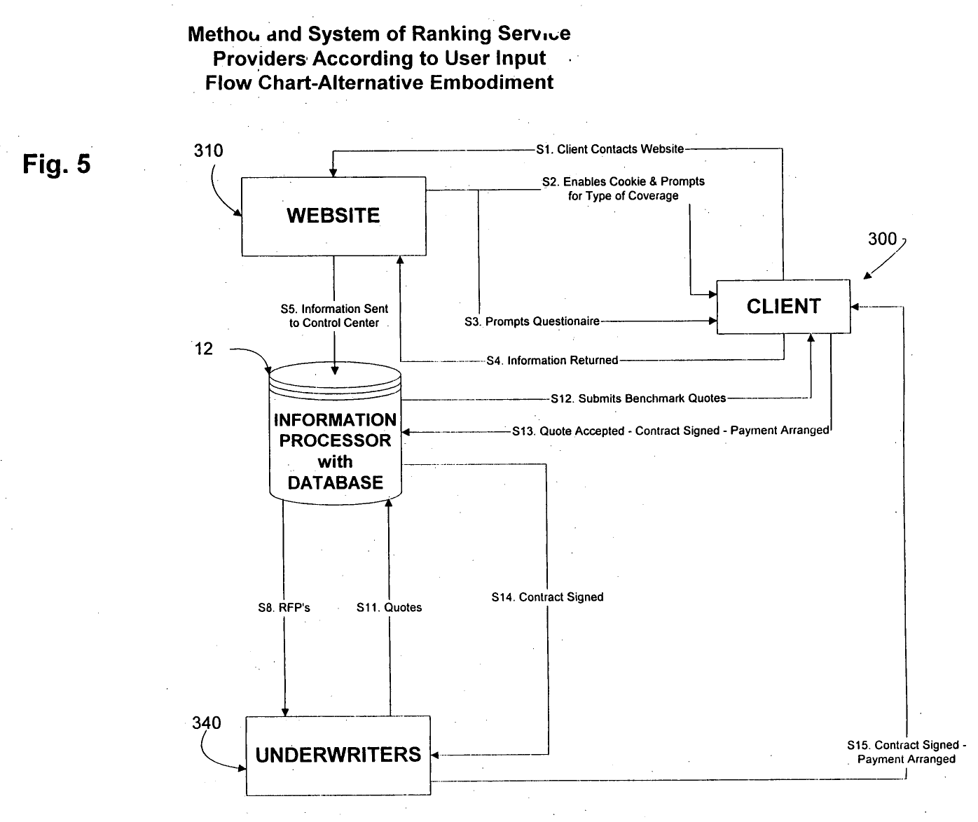

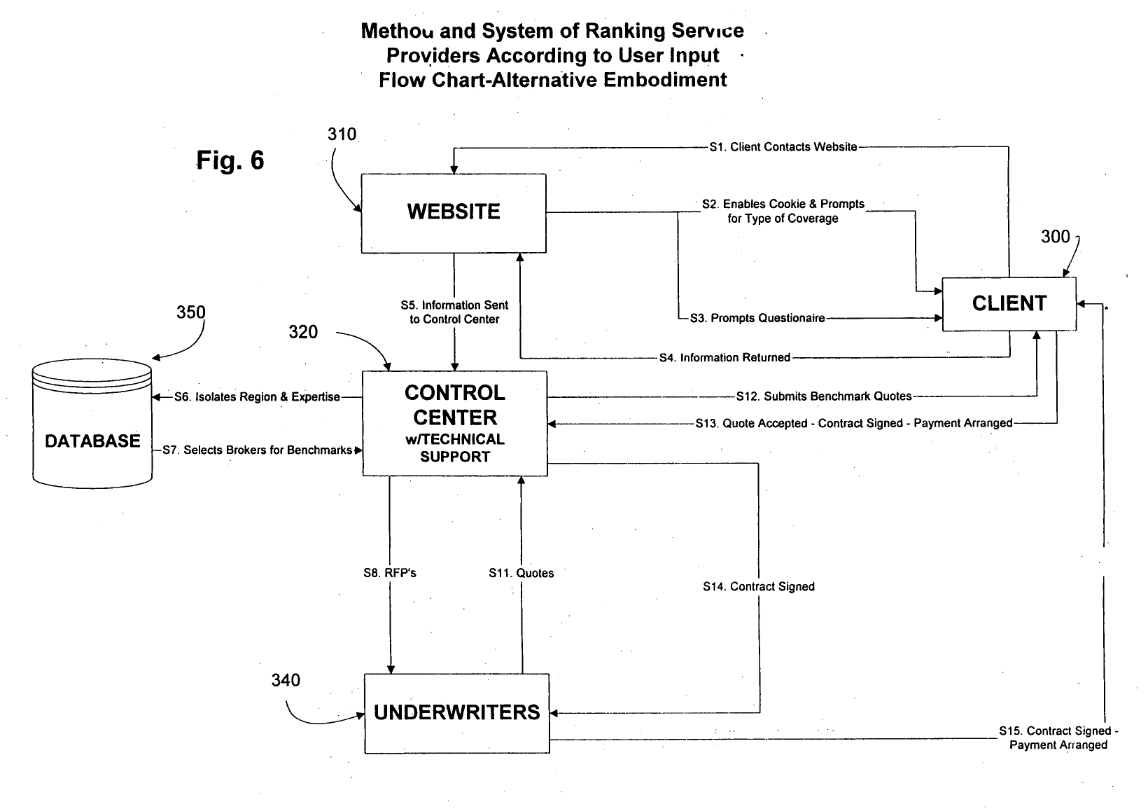

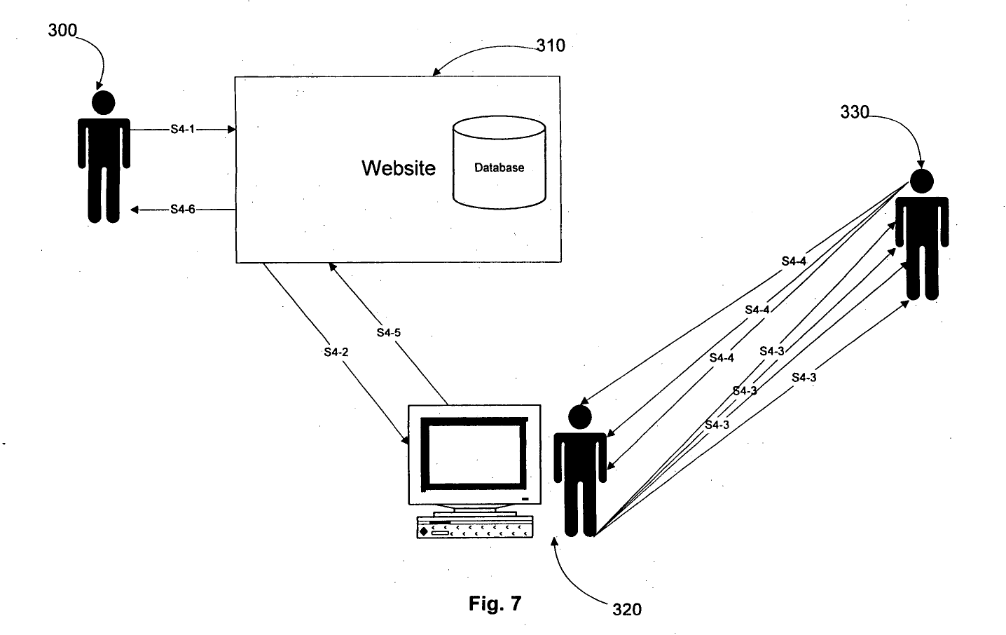

In some embodiments (FIGS. 3 and 6), human operators put together the RFP's (S8) and send them to brokers (S8) (FIG. 3), or the RFP's (S8) are sent directly to underwriters 340 (FIG. 6). In alternate embodiments (FIGS. 4 and 5), results from database 350 are computer generated and Request For Proposals (RFP's) are sent to either brokers 330 (S8) (FIG. 4) or to underwriters (S8) (FIG. 5). In another embodiment, human operators review the computer generated RFP's before being forwarded to brokers (330). Brokers 330, likewise, send Request For Proposals (RFP's) to the underwriters 340 (S9). The underwriters 340 return quotes to brokers 330 (S10) and brokers 330 prepare quotes based on the quotes from underwriters 340 and send the quotes to Control Center 320 (S11) (FIG. 4). In the case where RFP's (S8) are sent directly to underwriters 340, the quotes (S11) are returned to Information Processor 12 (FIG. 5) or to Control Center 320 (FIG. 6). Control Center 320 submit quotes matching the benchmarks to client 300 along with a contract to be sighed if the client accepts the proposal and payment arrangements (S12) (FIGS. 3 and 6) or the process is automated and prepared by Information Processor 12 (FIGS. 4 and 5). Client 300 reviews the quote and is free to reject it. If the quote is acceptable, a contract between the Control Center 320 and client 300 is signed and payment arrangements are made (S13) and returned to Control Center 320.

It is preferred that brokers 330 and/or underwriters 340 enter into a contractual agreement so as to generate revenue (S14). In the preferred embodiment, when client 300 accepts a quote and enters into a contractual arrangement with Control Center 320, the contact information regarding the selected broker or underwriter is provided to client 300. Broker 330 then prepares and sends a contract between client 300 and broker 330 along with specifics such as payment arrangements to be signed to client 300 (S15). Of course, many embodiments are possible and would-still-be within the spirit of the present-invention.

FIG. 7 is a simplified drawing illustrating the basic interchange between the Website 310, Control Center 320 (or Information Processor with database 12) and Brokers 330 according to the principals of the present invention. Client 300 contacts web site 310 and inputs their requests. A quote request is sent to the Control Center 320 based on the information provided by client 300. Preferably, the quote requests are formatted and standardized so that they can be easily manipulated by computer. The quotes are then forwarded to a plurality of brokers 330 which meet the baseline criteria. Interested brokers 330 respond by sending a quote back to Control Center 320. A ranked list is compiled from those quotes meeting the specific needs of the client 300 and then displayed on a Website 310. In one embodiment, the client 300 must return to Website 310 periodically throughout a period of time (for example, one week) to view the results of his or her inquiry. The results will be displayed utilizing appropriate security measures such as password protection, etc. and will be displayed as the results are made available to Control Center 320. In this way, client 300 is able to view the progress of his or her request as the results become available.

In an alternate embodiment, results would be displayed “instantaneously” while client 300 is still viewing Website 310. This embodiment requires an extensive database and cooperation between Control Center 320, brokers 330 and underwriters 340 (see FIG. 3) in order to provide real time results. Of course, clients with special needs could still be handled on an individual basis by Control C-enter 320.

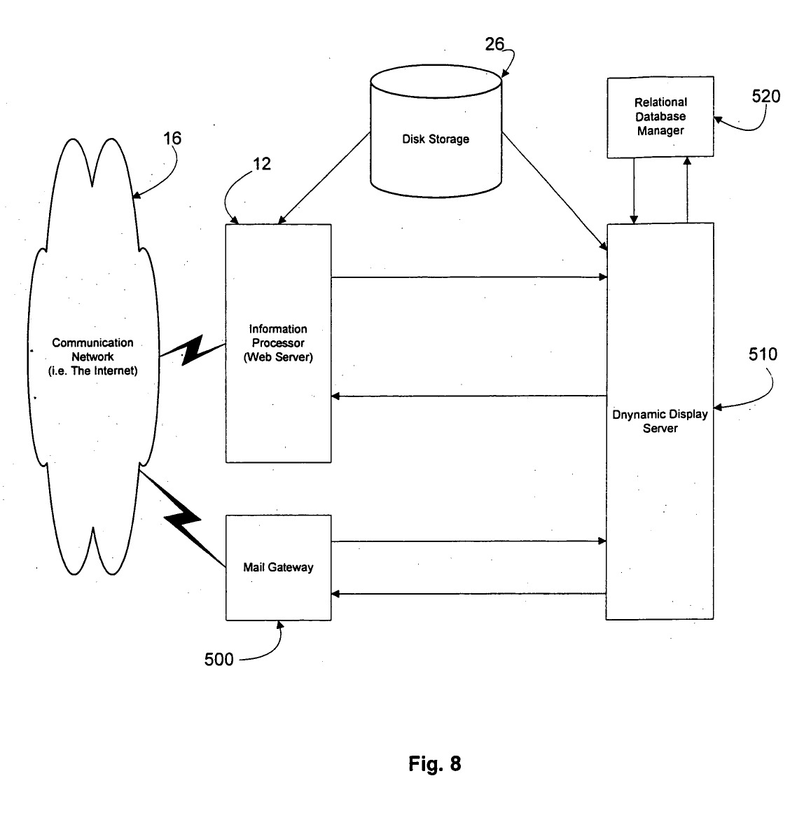

FIG. 8 illustrates a preferred embodiment for providing content to a website (not shown). User requests from communication network (i.e., Internet 16) are sent to Information Processor 12 (Web Server). In this embodiment, Information Processor 12 retrieves static pages from disk storage 26 and dispatches requests for “on the fly” website programming (for example, Cold Fusion) to display the dynamic material on a website. Dynamic display server 510 is linked to relational database manager 520. Dynamic website content is then sent back to information program processor 12 to be displayed through the internet 16 on website. A mail gateway 500 is also linked to dynamic display server 510 by which e-mail is sent to mail gateway 500 and distributed through Internet 16 to the intended recipient (not shown).

According to a preferred embodiment, each customer is identified by a unique e-mail address. In addition to a unique e-mail address, it is preferred that each customer have a password for security. When logging on the website page, a client 300 (not shown) uses their e-mail and password to log in. It is preferred that a single client can have multiple customer IDs if they have multiple e-mail addresses. Although not necessary for log in purposes, a business name is eventually required if the client contracts for services. Preferably, each time a customer requests information, a unique information request number is created. Thus, a customer may have multiple requests, but each request will be uniquely identified by a specific request number.

It is important that clients be able to request quotes for more than one form of insurance. For example, a client may want both employee health insurance as well as employee life insurance coverage. One embodiment (to reduce complexity) does not support high end customers where discounts are provided by brokers if customers obtain more than one type of coverage. Another simplified embodiment includes not allowing customers to use the present invention if premiums are under $5,000.00 per year. In yet another simplification embodiment, high end customers with two or more contracts for the same category of coverage (for example, fire and theft coverage for a main office and a branch office) will not be able to use the present invention. These embodiments are made for the purpose of simplification and other embodiments could include these kind of clients.

Clients change e-mail addresses from time to time, therefore, it is preferred that customers have access to a user profile where they can update any changes in their address, e-mail, phone number or password change requests, etc. to ensure that user information remains current. Since users are known to forget their e-mail addresses/passwords, it is preferred to include a mechanism that would help users retrieve this information securely. Additionally, in the preferred embodiment, user name/e-mail/password would not be case sensitive to avoid login problems.

According to one embodiment of the present invention, income is generated by participating in the savings generated by the premium reduction realized by a user contracting for servicing with a provider matched by using the present invention. A user inputs their service needs in response to a questionnaire that is generated and displayed on a Website. The questionnaire is preferably responsive to the type of coverage a client is interested in. A tailored questionnaire is generated depending upon the initial request. Based on the response to the questionnaire, the client is eventually presented with a ranked list of providers meeting their needs. The client is preferably given a list that does not include company names, addresses or any other contact information. The ranked list merely presents the kind of coverage and the premium to be paid. Client can then compare the premiums to the premiums they are currently paying in order to compare the cost. If the client decides to purchase the service, a contract is signed before contact information is released to client.

According to another embodiment of the present invention, income is generated by charging the client a percentage based on all the client business transacts through the present invention. According to this embodiment, client would agree to pay a percentage or other fee based on the business they contract for through their use of the present invention. Additionally in another embodiment, the brokers would be charged either a flat fee or a percentage for participation in the present invention according to one embodiment.

According to yet another embodiment, underwriters would pay a percentage or a flat fee to participate in the present invention.

Although it is preferred that the brokers act as an intermediary between underwriters 340 and clients 300, it is not essential. Clients after inputting their needs can be directly matched to underwriters. This would eliminate the need for brokers and provide lower cost insurance. This is especially important for the over 5 million small businesses in the United States.

According to one embodiment, if the client currently has no insurance, then the client would be required to pay a flat fee or a percentage in order to participate in the present invention. This way, although the client would not have a premium reduction savings with which to provide income, a flat fee or a percentage fee would provide income.

According to a preferred embodiment, brokers are maintained as an intermediary between underwriters and clients. Brokers provide an important function by tailoring insurance services and providing expertise to the clients.

Although the present invention has been described in relation to particular embodiments thereof, many other variations and modifications and other uses will become apparent to those skilled in the art.

What is claimed is:

1. A system for facilitating the selection and purchase of an insurance policy by a client from a broker, said system comprising:
a computer;
a database accessible by said computer, said database having stored thereon broker benchmarks, the broker benchmarks comprising data indicative of at least one broker specialty for each broker;
computer executable instructions embodied on a computer readable medium for receiving from the client information relating to the client and relating to a desired insurance policy;
computer executable instructions embodied on a computer readable medium for comparing, based upon preselected criteria, the information relating to the client and relating to the desired insurance policy with the broker benchmarks to identify at least one appropriate broker;
computer executable instructions embodied on a computer readable medium for generating and transmitting to the at least one identified appropriate broker requests for manually prepared proposals individually tailored to the client;
computer executable instructions embodied on a computer readable medium for receiving proposals from the at least one identified appropriate broker in response to the requests for proposals; and
computer executable instructions embodied on a computer readable medium for transmitting the received proposals to the client.

2. The system of claim 1 wherein the data indicative of at least one broker specialty comprises an alphanumeric code, wherein the information relating to the client comprises an alphanumeric code indicative of a business type of the client, and wherein a broker is identified as being appropriate only if the alphanumeric code which comprises the data indicative of the at least one broker specialty matches the alphanumeric code indicative of the business type of the client.

3. The system of claim 2 wherein the alphanumeric code which comprises the data indicative of the at least one broker specialty and the alphanumeric code indicative of the business type of the client comprise SIC codes.

4. The system of claim 1 wherein the broker benchmarks further comprise data indicative of a geographic location of each broker.

5. The system of claim 4 wherein the broker benchmarks further comprise, for each broker, data indicative of at least one of an amount of business the broker conducts, a size of the broker, a length of time the broker has been in business, whether the broker is a public or private entity, and whether the broker is a headquarters or a branch location.

6. The system of claim 1 wherein said computer executable instructions embodied on a computer readable medium for receiving from the client information relating to the client and relating to a desired insurance policy comprises:
computer executable instructions embodied on a computer readable medium for transmitting a questionnaire to the client soliciting information relating to the client and relating to a desired insurance policy; and
computer executable instructions embodied on a computer readable medium for receiving from the client responses to the questionnaire indicative of information relating to the client and relating to a desired insurance policy.

7. The system of claim 6 further comprising computer executable instructions embodied on a computer readable medium for receiving from the client an indication of a desired type of insurance policy, and wherein the questionnaire solicits information specific to the desired type of insurance policy.

8. The system of claim 1 wherein the at least one appropriate broker comprises a plurality of appropriate brokers.

9. The system of claim 1 further comprising computer executable instructions embodied on a computer readable medium for generating a contract based upon each received proposal, and for transmitting the contracts to the client along with the received proposals.

10. The system of claim 1 further comprising computer executable instructions embodied on a computer readable medium for receiving from the client an indication of a selected proposal, and for generating and transmitting to the client a contract based upon the selected proposal.

11. The system of claim 1 further comprising computer executable instructions embodied on a computer readable medium for transmitting broker contact information along with the received proposals.

12. The system of claim 1 further comprising computer executable instructions embodied on a computer readable medium for receiving from the client an indication of a selected proposal, and for transmitting to the broker which submitted the selected proposal an indication that the proposal has been selected by the client.

13. A system for facilitating the selection and purchase of an insurance policy by a client from a broker, said system comprising:
a computer;
a database accessible by said computer, said database having stored thereon broker benchmarks, the broker benchmarks comprising an alphanumeric SIC code indicative of at least one broker specialty for each broker;
computer executable instructions embodied on a computer readable medium for receiving from the client information relating to the client and relating to a desired insurance policy, the information relating to the client comprising an alphanumeric SIC code indicative of a business type of the client;
computer executable instructions embodied on a computer readable medium for comparing, based upon preselected criteria, the information relating to the client and relating to the desired insurance policy with the broker benchmarks to identify at least one appropriate broker, wherein a broker is identified as being appropriate only if the alphanumeric SIC code which comprises the data indicative of the at least one broker specialty matches the alphanumeric SIC code indicative of the business type of the client;
computer executable instructions embodied on a computer readable medium for generating and transmitting to the at least one identified appropriate broker requests for manually prepared proposals individually tailored to the client;
computer executable instructions embodied on a computer readable medium for receiving proposals from the at least one identified appropriate broker in response to the requests for proposals; and
computer executable instructions embodied on a computer readable medium for transmitting the received proposals to the client.

14. A method for facilitating the selection and purchase of an insurance policy by a client from a broker, said method comprising the steps of:
providing a database having stored thereon broker benchmarks, the broker benchmarks comprising data indicative of at least one broker specialty for each broker;
receiving from the client information relating to the client and relating to a desired insurance policy;
comparing, based upon preselected criteria, the information relating to the client and relating to the desired insurance policy with the broker benchmarks to identify at least one appropriate broker;
generating and transmitting to the at least one identified appropriate broker requests for manually prepared proposals individually tailored to the client;
receiving proposals from the at least one identified appropriate broker in response to the requests for proposals; and transmitting the received proposals to the client.

15. The method of claim 14 wherein the data indicative of at least one broker specialty comprises an alphanumeric code, wherein the information relating to the client comprises an alphanumeric code indicative of a business type of the client, and wherein a broker is identified as being appropriate only if the alphanumeric code which comprises the data indicative of the at least one broker specialty matches the alphanumeric code indicative of the business type of the client.

16. The method of claim 15 wherein the alphanumeric code which comprises the data indicative of the at least one broker specialty and the alphanumeric code indicative of the business type of the client comprise SIC codes.

17. The method of claim 15 wherein the broker benchmarks further comprise data indicative of a geographic location of each broker.

18. The method of claim 17 wherein the broker benchmarks further comprise, for each broker, data indicative of at least one of an amount of business the broker conducts, a size of the broker, a length of time the broker has been in business, whether the broker is a public or private entity, and whether the broker is a headquarters or a branch location.

19. The method of claim 14 wherein said step of receiving from the client information relating to the client and relating to a desired insurance policy comprises the steps of:
transmitting a questionnaire to the client soliciting information relating to the client and relating to a desired insurance policy; and
receiving from the client responses to the questionnaire indicative of information relating to the client and relating to a desired insurance policy.

20. The method of claim 19 further comprising the step of receiving from the client an indication of a desired type of insurance policy, and wherein the questionnaire solicits information specific to the desired type of insurance policy.

21. The method of claim 14 wherein the at least one appropriate broker comprises a plurality of appropriate brokers.

22. The method of claim 14 further comprising the step of generating a contract based upon each received proposal, and transmitting the contracts to the client along with the received proposals.

23. The method of claim 14 further comprising the step of receiving from the client an indication of a selected proposal, and generating and transmitting to the client a contract based upon the selected proposal.

24. The method of claim 14 further comprising the step of transmitting broker contact information along with the received proposals.

25. The method of claim 14 further comprising the step of receiving from the client an indication of a selected proposal, and transmitting to the broker which submitted the selected proposal an indication that the proposal has been selected by the client.

26. A method for facilitating the selection and purchase of an insurance policy by a client from a broker, said method comprising the steps of:
providing a database having stored thereon broker benchmarks, the broker benchmarks comprising an alphanumeric SIC code indicative of at least one broker specialty for each broker;
receiving from the client information relating to the client and relating to a desired insurance policy, the information relating to the client comprising an alphanumeric SIC code indicative of a business type of the client;
comparing, based upon preselected criteria, the information relating to the client and relating to the desired insurance policy with the broker benchmarks to identify at least one appropriate broker, wherein a broker is identified as being appropriate only if the alphanumeric SIC code which comprises the data indicative of the at least one broker specialty matches the alphanumeric SIC code indicative of the business type of the client;
generating and transmitting to the at least one identified appropriate broker requests for manually prepared proposals individually tailored to the client;
receiving proposals from the at least one identified appropriate broker in response to the requests for proposals; and
transmitting the received proposals to the client.
